(19) United States
(12) Patent Application Publication
(10) Pub. No.: US 2026/0258641 A1
(43) Pub. Date: Sep. 3, 2026

(54) METHOD AND SYSTEM FOR FOG HARVESTING AND MIST ELIMINATION

(71) Applicant: Northwestern University, Evanston, IL (US)

(72) Inventors: Jonathan F. Switzer, Seattle, WA (US); Kyoo-Chul Kenneth Park, Evanston, IL (US); Leyun Feng, Evanston, IL (US)

(21) Appl. No.: 18/867,623

(22) PCT Filed: May 25, 2023
(86) PCT No.: PCT/US2023/023555

§ 371 Date: Nov. 20, 2024

Related U.S. Application Data
(60) Provisional application No. 63/345,752, filed on May 25, 2022.

(51) Int. Cl. E03B 3/28; B01D 5/00; B01D 45/08

(52) U.S. Cl. CPC E03B 3/28; B01D 5/009; B01D 45/08

(57) ABSTRACT

A system for harvesting fog that includes a core, where the core features a rod-like structure that is configured to direct accumulated fog droplets in a downward direction. The system also includes a plurality of trichomes mounted to the core such that each of the trichomes is configured to accumulate the fog droplets. Interstitial spaces are formed in between trichomes to wick the fog droplets and coalesce them into one or more continuous fluid streams along a length of the core. The system collects the accumulated fog droplets and directs them in a downward direction along the core towards a bulk outflow.

### CROSS-REFERENCE TO RELATED APPLICATION

The present application claims the priority benefit of U.S. Provisional Patent App. No. 63/345,752 filed on May 25, 2022, the entire disclosure of which is hereby incorporated by reference herein.

### BACKGROUND

Fog harvesters capture droplets of water suspended in air and transport the water to a bulk outflow. The same phenomena and mechanisms used in fog harvesting can also be used to separate other sets of immiscible fluids, which is useful in several other applications. Typically, the components of a fog harvester include a fog collector, bulk outflow, and structural framing. The fog collector is designed to capture as many fog droplets as possible while allowing air to pass through, and is often composed of a specialized metal or plastic mesh sheet. The fog collector is suspended in the fog flow by structural framing. Fog droplets collide with the collector, coalesce, and travel down the collector with gravity into the bulk outflow below. In some traditional implementations, there may be one layer or multiple layers of fog collectors suspended within the same structural framing.

### SUMMARY

An illustrative system for harvesting fog includes wicking transport structures that have a core, where the core is in the form of a rod-like structure that is configured to direct accumulated fog droplets in a downward direction. The wicking transport structures also include a plurality of trichomes mounted to the core such that each of the trichomes is configured to accumulate the fog droplets. There are interstitial spaces in between trichomes to wick the fog droplets and coalesce them into one or more continuous fluid streams along a length of the core. The system also includes a bulk outflow to which the accumulated fog droplets are directed in the downward direction along the core.

In one embodiment, the core comprises a pair of wires that are twisted together to form a helical channel. In another embodiment, the wires are formed from aluminum. In another embodiment, the system includes a frame to which the core is mounted such that the core is positioned at an angle relative to a ground surface. The system can also include one or more tubes or troughs that are configured to receive the accumulated fog droplets from an end of the core and direct the accumulated fog droplets to the bulk outflow. In another embodiment, a tube of the one or more tubes includes an opening sized to receive a bottom tip of the core such that the accumulated fog droplets release from the bottom tip of the core directly into the tube.

In an illustrative embodiment, the plurality of trichomes comprise thin, flexible fibers. In another embodiment, the core comprises a roughly textured core, a smooth core, a cylindrical core, a fluted core, a polygonal core, or a rectangular core, a zig-zag core, or a wavy core. In one embodiment, the core includes one or more internal channels. In another embodiment, the trichomes are at an angle of between 0° and 180° relative to the core. In another embodiment, the core and the plurality of wicking transport structures are formed by a three-dimensional printer.

In one embodiment, a cross-section of a trichome is cylindrical, elliptical, rectangular, or square. In another embodiment, a trichome has a flat fin shape, a rectangular shape, a curly shape, or a looping shape. In another embodiment, the plurality of trichomes includes trichomes having different flexural stiffness such that the core has non-uniform properties along its length. In one embodiment, the plurality of trichomes includes trichomes mounted at different angles relative to an axis of the core such that the core has non-uniform properties along its length. In another embodiment, the plurality of trichomes includes trichomes having different lengths or shapes such that the core has non-uniform properties along its length. In one embodiment, spacing between trichomes varies along a length of the core such that the core has varying spatial density of trichomes along its length.

An illustrative method of forming a fog harvesting system includes forming a core as a rod-like structure that is configured to direct accumulated fog droplets in a downward direction. The method also includes mounting a plurality of trichomes to the core such that each of the trichomes is configured to accumulate the fog droplets. The plurality of trichomes are mounted such that interstitial spaces are formed in between trichomes to wick the fog droplets and coalesce them into one or more continuous fluid streams along a length of the core. The method further includes positioning a bulk outflow to collect the accumulated fog droplets that are directed in the downward direction along the core.

In one embodiment, the method includes twisting a pair of wires together to form the core as a helical channel. The method can also include forming a frame and mounting the core to the frame such that the core can be positioned at an angle relative to a ground surface. The method can also include positioning one or more tubes or troughs to receive the accumulated fog droplets from an end of the core. In an illustrative embodiment, the one or more tubes are positioned to direct the accumulated fog droplets to the bulk outflow. In another embodiment, a tube of the one or more tubes includes an opening sized to receive a bottom tip of the core such that the accumulated fog droplets release from the bottom tip of the core directly into the tube.

In one embodiment, the method includes forming the plurality of trichomes as thin, flexible fibers and mounting the thin, flexible fibers by positioning a portion of the fibers in between wires that form the core. In another embodiment, the method includes forming the core as a braid of two or more wires, and applying a texture to an outer surface of the core. In one embodiment, the method includes forming one or more internal channels in the core.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A shows examples of wicking transport structures without trichomes in accordance with an illustrative embodiment.

FIG. 1B shows wicking transport structures with trichomes in accordance with an illustrative embodiment.

FIG. 1C depicts a three dimensional (3D)-printed wicking transport structure in accordance with an illustrative embodiment.

FIG. 2A shows a 6.1 millimeter (mm) diameter wicking transport structure in accordance with an illustrative embodiment.

FIG. 2B shows a 2.5 mm diameter wicking transport structure in accordance with an illustrative embodiment.

FIG. 3 depicts pairs of wicking transport structures after 30 minutes of exposure to 5 meters/second (m/s) fog flow in accordance with an illustrative embodiment.

FIG. 4A depicts an experimental setup within a fog wind tunnel, showing a wicking transport structure, the sample mount above, and the drip funnel below in accordance with an illustrative embodiment.

FIG. 4B shows 0.32 mm diameter superhydrophilic (SHphi) aluminum wires used for comparison in accordance with an illustrative embodiment.

FIG. 4C depicts 0.32 mm diameter hydrophilic (Hphi) aluminum wires used for comparison in accordance with an illustrative embodiment.

FIG. 4D shows 6.35 mm diameter stereolithography 3D-printed (SLA) cylinders used for comparison in accordance with an illustrative embodiment.

FIG. 4E shows 3 mm diameter SLA cylinders used for comparison in accordance with an illustrative embodiment.

FIG. 4F shows 0.8 mm diameter SLA cylinders used for comparison in accordance with an illustrative embodiment.

FIG. 4G shows 5.6 mm diameter wicking transport structures with coarse trichomes in accordance with an illustrative embodiment.

FIG. 4H shows 6.1 mm diameter wicking transport structures with fine trichomes in accordance with an illustrative embodiment.

FIG. 4I shows 2.5 mm diameter wicking transport structures with fine trichomes in accordance with an illustrative embodiment.

FIG. 5 is a chart showing fog collection rate per area of subcomponent units of various fog collector designs and estimated fog collection rates of corresponding full fog collectors after 30 minutes of exposure to 5 m/s fog flow in accordance with an illustrative embodiment.

FIG. 6A shows a horizontal section of aluminum wire with a superhydrophilic (SHPhi) surface coating that is placed in contact with a vertical wicking transport structure in accordance with an illustrative embodiment.

FIG. 6B is a closeup view of FIG. 6A which shows the complete lack of droplet pinning at the intersection in accordance with an illustrative embodiment.

FIG. 6C shows that significant droplet pinning occurs between horizontal superhydrophilic aluminum wires and vertical untreated hydrophilic (HPhi) aluminum wires in accordance with an illustrative embodiment.

FIG. 6D shows that significant droplet pinning occurs between horizontal and vertical untreated hydrophilic aluminum wires in accordance with an illustrative embodiment.

FIG. 6E shows the complete lack of droplet pinning at the intersections between wicking transport structures and untreated hydrophilic aluminum wires in accordance with an illustrative embodiment.

FIG. 6F shows the complete lack of droplet pinning at the intersections between wicking transport structures and relatively thick 2 mm diameter aluminum wires in accordance with an illustrative embodiment.

FIG. 6G shows the complete lack of droplet pinning at the intersections between wicking transport structures and relatively thin 0.32 mm diameter aluminum wires in accordance with an illustrative embodiment.

FIG. 7A shows a cross-section of a wicking transport structure core made from twisted wires in accordance with an illustrative embodiment.

FIG. 7B shows a cross-section of a smooth cylindrical wicking transport structure core that has no external channels in accordance with an illustrative embodiment.

FIG. 7C shows a cross-section of a roughly-textured wicking transport structure core in accordance with an illustrative embodiment.

FIG. 7D shows a cross-section of a polygonal wicking transport structure core in accordance with an illustrative embodiment.

FIG. 7E shows a cross-section of a fluted wicking transport structure core in accordance with an illustrative embodiment.

FIG. 7F shows a cross-section of a wicking transport structure core with internal channels in accordance with an illustrative embodiment.

FIG. 8A shows a cross-section of a wavy non-planar fog collector made up of many wicking transport structures in accordance with an illustrative embodiment.

FIG. 8B shows a cross-section of a pleated non-planar fog collector made up of many wicking transport structures in accordance with an illustrative embodiment.

FIG. 8C shows a cylindrical non-planar fog collector with wicking transport structures in accordance with an illustrative embodiment.

FIG. 8D shows conical and domed non-planar fog collectors with wicking transport structures in accordance with an illustrative embodiment.

FIG. 9A shows a cross-section of a wicking transport structure with a cylindrical trichome outline in accordance with an illustrative embodiment.

FIG. 9B shows a cross-section of a wicking transport structure with a rectangular trichome outline in accordance with an illustrative embodiment.

FIG. 9C shows a cross-section of a wicking transport structure with an irregularly-shaped trichome outline in accordance with an illustrative embodiment.

FIG. 10 shows a side view of a wicking transport structure with asymmetrical features that vary along its length in accordance with an illustrative embodiment.

FIG. 11A shows a 6 mm diameter 3D-printed wicking transport structure with a smooth core having no channels in accordance with an illustrative embodiment.

FIG. 11B shows a 3 mm diameter 3D-printed wicking transport structure with a smooth core having no channels in accordance with an illustrative embodiment.

FIG. 12A shows a 6 mm diameter 3D-printed wicking transport structure with a smooth core having no channels in accordance with an illustrative embodiment.

FIG. 12B shows a 3 mm diameter 3D-printed wicking transport structure with a smooth core having no channels in accordance with an illustrative embodiment.

FIG. 13 shows a closeup view of a cluster of flexible trichomes that have formed into a conical shape on a wicking transport structure in accordance with an illustrative embodiment.

FIG. 14 shows a closeup view of a wicking transport structure in accordance with an illustrative embodiment.

FIG. 15 shows a closeup view of a trichome on a wicking transport structure in accordance with an illustrative embodiment.

FIG. 16 shows equal lengths of various 6 mm diameter wicking transport structures having different densities of trichomes in accordance with an illustrative embodiment.

FIG. 17 is a chart showing fog collection rates of equal lengths of 6 mm diameter wicking transport structures having different densities of trichomes during exposure to 2 m/s fog flow in accordance with an illustrative embodiment.

FIG. 18 shows the complete lack of droplet pinning at the intersections between 6 mm diameter wicking transport structures having different densities of trichomes in accordance with an illustrative embodiment.

FIG. 19 depicts a fog harvesting system in accordance with an illustrative embodiment.

### DETAILED DESCRIPTION

Global water shortages are anticipated to severely worsen with climate change in coming decades. The glaciers that supply much of civilization's water during dry seasons are rapidly disappearing due to globally observed reductions in glacial snowfall and rising temperatures. Unaddressed, this will lead to severe political and economic instability across much of the world. Developing effective alternative water sources is a very important strategic objective for preventing such a disaster.

Fog water is an abundant resource across the globe that humanity has so far been largely unable to utilize. The atmosphere contains several times more fresh water than all of the Earth's lakes and rivers combined. As climate change and the disappearance of river-fueling glaciers deeply impact life for billions of people worldwide, a large amount of atmospheric moisture condenses into dense fog clouds across the world's coastlines and mountain ranges each day. The cooling towers of most power plants spew out plumes of fog droplets, wasting vast quantities of unutilized cooling water per plant per year. Until now, fog collectors that capture water from fog have been inefficient, expensive, and impractical. The main problem is that existing fog collectors cannot efficiently transport water from where droplets initially impact the collector to the bulk outflow. Instead, existing fog collectors clog or release water back into the fog flow. More recent fog collector designs solve the water transport problem, but sacrifice other important aspects of fog collection performance such as overall efficiency, durability, and cost. Without making any such sacrifices, the inventors have developed low-cost, bio-inspired fog collector designs that solve the water transport problem and achieve unprecedented fog collection performance. The proposed fog collector designs represent a foundational new tool in humanity's search for long-term water sustainability.

As discussed, a fog collector (or fog harvester) is a system designed to capture droplets of water suspended in air and transport the water droplets to a bulk outflow. When evaluating the performance of a fog collector, it is important to consider its overall collection area fraction (AF_{c}). The AF_{c} is the proportion of the projected area of a collector's structures and components to the total frontal area taken up by collector, given by Equation 1 below:

$${AF}_{c} = {A}_{p} / {A}_{c} . \qquad Eq . 1$$

In Equation 1, AF_{c} is the overall collection area fraction of the fog collector as noted above, A_{c} is the overall frontal area of the fog collector measured from the direction of oncoming flow, and Aₚ is the projected area of the fog collector's component parts measured from the direction of oncoming flow.

As an example, one can imagine a mesh-type fog collector held taught within a square frame with a 1 m side length, positioned perpendicular to the oncoming flow (A_{c}=1 m²). If the mesh has 0.75 m² of open gaps for air to pass through when viewed from upstream, and the total projected area of its wires (Aₚ) is 0.25 m² when viewed from upstream, then the fog collector has an AF_{c} of 0.25. If the same mesh were instead sloped at 60° to the free stream flow direction, then A_{c}, Aₚ, and AF_{c} would need to be remeasured from the new free stream flow direction, as shown in the example of Equation 2:

$${A}_{c} = sin ( 60 ° ) \cdot ( 1 {m}^{2} ) = 0.5 {m}^{2} \qquad Eq . 2$$

The overall performance of a fog collector is quantified by its overall fog collection efficiency (η), which is the ratio between the fog collection rate and the total fog flow rate, as shown in Equation 3:

$$\frac{{v}^{′}}{{v}_{total}^{′}} = η = {η}_{ac} \cdot {η}_{d} \cdot {η}_{dr} , \qquad Eq . 3$$

Equation 3 shows that the fog collection efficiency η of a fog collector is the product of its aerodynamic collection efficiency (η_{ac}), deposition efficiency (η_{d}), and drainage efficiency (η_{dr}). In Equation 3, v′ is the fog collection rate, and vₜₒₜₐₗ′ is the total fog flow rate. The value η_{ac} accounts for aerodynamic effects on the scale of the fog collector. Also, η_{ac} is the proportion of fog in the oncoming free stream that passes through the fog collector rather than diverting around it. Oftentimes, flow resistance from the fog collector causes a portion of the oncoming fog flow to divert around the collector. The value η_{ac} is largely dependent on AF_{c} of the fog collector at any given time. When oncoming flow diverts around the collector due to flow resistance, η_{ac} is less than 1. Conversely, additional flow may be drawn into some fog collectors, such as those with intake fans, producing η_{ac} greater than 1. The variable η_{ac} may equal 1 for fog collectors with negligible flow resistance such as very sparse arrays or single wires, or when fog flows are constrained within ducts and cannot pass around the fog collector. The variable η_{d} accounts for aerodynamic effects on the scale of small subcomponents of the fog collector, such as those around individual wires of a mesh.

As a fog flow enters a fog collector, individual subcomponents of the fog collector (such as individual wires of a grid mesh) generate local aerodynamic effects that cause fog droplets to deviate further from their free stream trajectories. Some droplets that were on trajectories to collide with the subcomponent are diverted by these local aerodynamic effects and pass through the fog collector instead. Other droplets that were on trajectories to pass through the fog collector are diverted and collide with the subcomponent instead. The value η_{d} is the overall quantity of fog water that collides with the fog collector as a proportion of the total amount of fog water that was on a trajectory to collide with the fog collector before it encountered local aerodynamic effects. The value η_{d} can be greater than 1, as is the case with collectors that use electrostatically driven fog collection to attract droplets that were on a trajectory to pass through the collector. The value η_{dr} is the rate of water transport to the bulk outflow, proportional to the total rate at which water collides with the collector. Increasing η_{d} is crucial to improving the performance of fog harvesting systems.

Analysis of fog collectors that include only a single superhydrophilic wire provide valuable insights. Superhydrophilic wires prevents the accumulation of droplets on the wire, allowing one to study the local aerodynamics of fog droplets near the wire. Recently, it was found experimentally that η_{d} of a fog collector that includes a single vertical aluminum wire in a simulated fog environment correlates to the Stokes number (St) of the flow around the wire. The value St is the response time of particles or droplets in the air flow around a solid body (τ_{particle}) proportional to the response time of the air flow (τ_{flow}). For a fog collector that includes a single wire, these relationships are expressed in Equations 4-6 below:

$$St = \frac{{τ}_{particle}}{{τ}_{flow}} = ( \frac{4 {ρ}_{water} {r}_{fog}^{2}}{9 {μ}_{air}} ) / ( \frac{{D}_{cylinder}}{{v}_{o}} ) \qquad Eq . 4$$

$${η}_{d} = \frac{st}{st + π / 2} \qquad Eq . 5$$

$${V}^{′} = {v}^{′} \cdot {A}_{p} ∝ {η}_{d} \cdot {A}_{p} \qquad Eq . 6$$

In Equations 4-6, St is the Stokes number, τ_{particle} is the response time of particles or droplets in the air flow around a solid body, τ_{flow} is the response time of the air flow, ρ_{water} is the density of water, r_{fog} is the fog droplet radius, μₐᵢᵣ is the air viscosity, vₒ is the flow speed, D_{cylinder} is the cylinder diameter, η_{d} is the deposition efficiency, V′ is the fog collection rate, v′ is the fog collection rate per unit area of the cylinder, and Aₚ is the projected frontal area of the cylinder facing the oncoming flow.

A greater St results in droplet trajectories deviating more from local air flow streamlines, leading to more droplet collisions with the wire. Supporting this conclusion, the inventors have observed that for any given fog flow, a thinner wire generates a flow condition with a greater St, and exhibits a greater η_{d} than a wider wire.

As discussed in more detail below, traditional fog collectors have room for improvement. The relationship between η_{d} and St for fog collectors that are composed of a single wire suggests that increasing the η_{d} of future fog collectors will involve designing them with thinner structures that are densely packed to increase St and AF_{c}. However, several serious problems have previously prevented the development of these ultra-high-η_{d} fog collectors. Clogging is one issue. As fog droplets impact a fog collector, they coalesce into larger droplets. Before these droplets can be transported away, surface tension forces at the interfaces between the droplets and the fog collector surfaces cause the droplets to spread and bridge between adjacent surfaces. If these interfacial forces overcome gravitational forces on a droplet, the droplet will pin to fog collector surfaces and reduce η_{dr}. Once the space between adjacent surfaces is clogged, fog flow around them will locally be characterized by the St of a larger cylinder as wide as the clogged passage and the bordering collector surfaces, greatly decreasing η_{d}.

As more passages of the fog collector clog and the overall resistance to flow through the fog collector increases, η_{ac} also drops. More densely packed and more spindly structures are more prone to clogging, as droplets are more easily able to bridge and spread within their smaller air passages. Typically, clogging results from inadequate transport of captured water due to contact angle hysteresis forces on individual droplets, and it affects fog collector surfaces of all wettabilities. The current state-of-the-art solution to clogging is a fog harp, a highly-tensioned harp-like array of vertical cylinders with no horizontal structures, which eliminates the intersections between wires where water droplets frequently pin. However, these structures are prone to tangling and require heavy frames to tension each short section of wire.

Strength and durability are also lacking in traditional systems. Strengthening the structure of a fog collector increases its maximum survivable fog or wind flow speed and reduces the likelihood of damage during transport, installation, and operation. Strength is crucial for outdoor installations, where fog collectors will have to withstand storms and other harsh conditions. Almost all current fog collector designs rely on fragile surface coatings, which limit their applications and cause performance degradation over time. The structural weakness of many state-of-the-art fog collectors increases the amount of structural framing needed for a given collector area. Making stronger fog collectors allows for larger unsupported sections of collector surface to withstand the same wind loads, simplifying and reducing the cost of mounting structures.

Re-entrainment is another issue with traditional fog collectors. After water impacts and coalesces into large droplets on a fog collector, those droplets experience aerodynamic drag forces from the passing air flow which increase exponentially with droplet size. If there is inadequate adhesion between the water and the fog collector surface, these drag forces will detach the droplet and it will be driven into the air flow. In applications where the objective is to collect water in a drip trough, such detachment is undesirable.

Additionally, most current fog collector designs involve the use of micro- and nano-textured coatings, nanoparticles, specialized materials, or complex chemical treatments. These processes dramatically increase the cost and difficulty of manufacturing, and limit the feasibility of using these systems for large-scale fog harvesting.

The inventors have developed wicking transport structures that achieve very high η, eliminate clogging, increase strength and durability, reduce re-entrainment, and enable low manufacturing costs when incorporated into fog collectors. As used herein, a ‘continuous fluid stream (CFS)’ is a single body of liquid along the direction of desirable liquid transport that is produced by the coalescence of many smaller individual droplets. The flow of liquid through CFSs is more efficient than the motion of droplets along a surface because CFSs are not subject to the interfacial contact angle hysteresis forces that resist the motion of droplets.

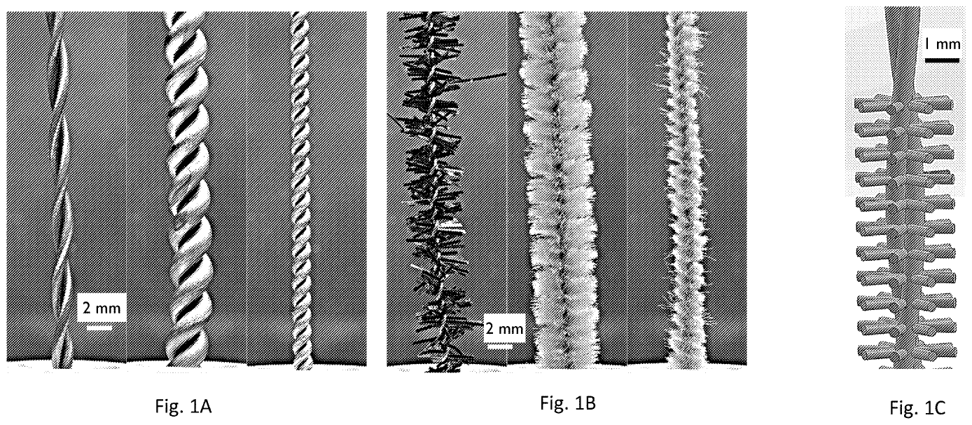

A ‘wicking transport structure (WTS)’ is a structure that captures fog droplets and coalesces them into a continuous fluid stream along its length when exposed to fog for a certain length of time. Various embodiments are shown in FIG. 1. A ‘core’ is the lengthwise core of a WTS, along which CFSs form. In an illustrative embodiment, the core is in the form of a rod-like structure to which trichomes may be mounted. A ‘trichome’ is a spike, fin, hair, or tuft that protrudes from the core of a WTS. Trichomes capture fog droplets and transport them towards the core. The dense grouping of trichomes around the core facilitates the formation of CFSs.”)

A ‘cross-link’ is a structural component that connects between two or more WTSs to form a textile. For instance, one embodiment is a textile of WTSs held together by metal wire cross-links that are laid perpendicular to the WTSs.

An ‘interstitial space’ is an open space between two or more trichomes through which a fluid can pass. The trichomes surrounding an interstitial space can be designed so that the surface interactions and hydrodynamic forces between the trichomes and fluids in the interstitial space cause certain behavior of the fluids. These manipulations can include repulsion, attraction, transport, or slowed evaporation of a fluid within the interstitial space.

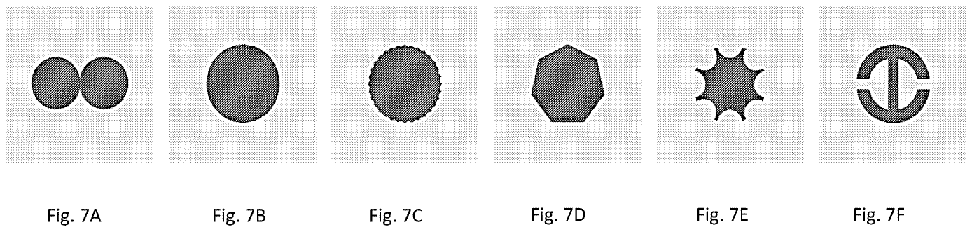

As discussed, wicking transport structures capture fog droplets and use the interstitial spaces between wires, fibers, pores, grooves, or trichomes to wick nearby droplets and coalesce them into one or more continuous fluid streams along the length of the wicking transport structure. These continuous fluid streams transport water from the area where it first contacts the wicking transport structure to the bulk outflow. FIGS. 1A-1C depict various wicking transport structures. Specifically, FIG. 1A shows examples of wicking transport structures made from twisted wires in accordance with an illustrative embodiment. These wicking transport structures are formed by twisting two untreated aluminum wires together to form a core with external helical channels. Continuous fluid streams form along the core within these helical external channels. Alternatively, a different type of material and/or a different number of wires may be used to form a core such as plastic, stainless steel, titanium, etc. Various core shapes are described in more detail below with reference to FIG. 7.

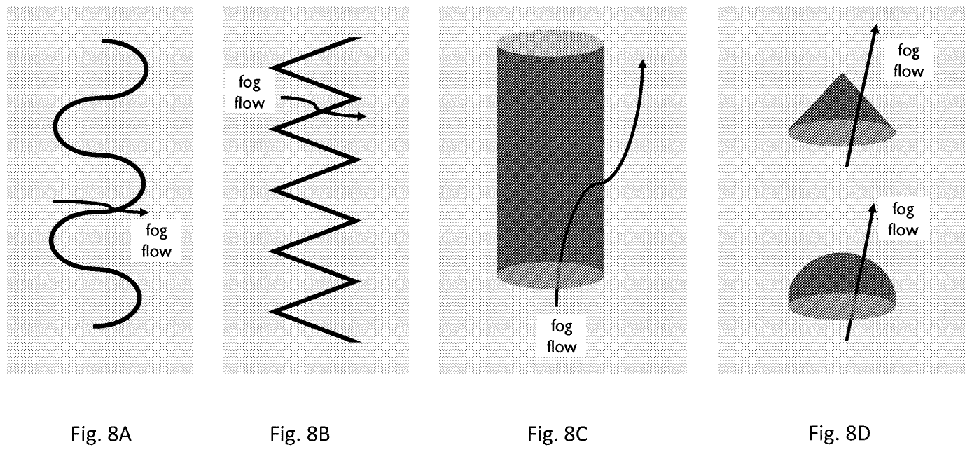

In an illustrative embodiment, a plurality of the wicking transport structures can be used to form the fog collector system. The cores can be mounted to a frame of any desired shape. The frame can be a rod, board, tube, or other structure from which the wicking transport structures are mounted. The frame can also be an enclosed structure that forms a perimeter about the wicking transport structures. The fog collector system formed from the wicking transport structures and the frame may be planar or take other shapes such as a wavy surface, a pleated surface, a cylinder, a cone, a dome, etc. Various wicking transport structure configurations are described in more detail below with reference to FIG. 8. The system can also include a reservoir that collects fog collected by the system. In one embodiment, one or more tubes or troughs can be used to carry the collected fog to the reservoir. In such an embodiment, a bottom tip of the core can be positioned within the tube (or trough) through an opening in the tube such that accumulated fog droplets that release from the bottom tip of the core land within the tube and are transported (e.g., via gravity) to the reservoir.

As discussed above, a trichome is a spike, fin, hair, or tuft that protrudes from the core of a WTS. Trichomes capture fog droplets and transport them towards the core. It was found that droplets reach a preferred lower surface energy state as they become absorbed by trichomes toward the core of a wicking transport structure, where droplets combine into a continuous fluid stream that flows downward with gravity. These continuous fluid streams facilitate rapid and efficient transport of absorbed water by eliminating the drag forces associated with the contact angle hysteresis of individual water droplets. The dense grouping of trichomes around the core facilitates the formation of continuous fluid streams.

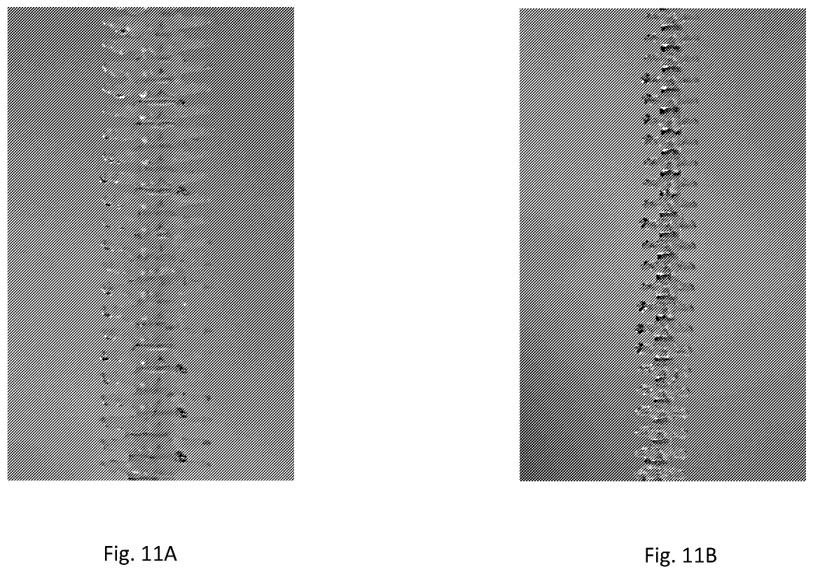

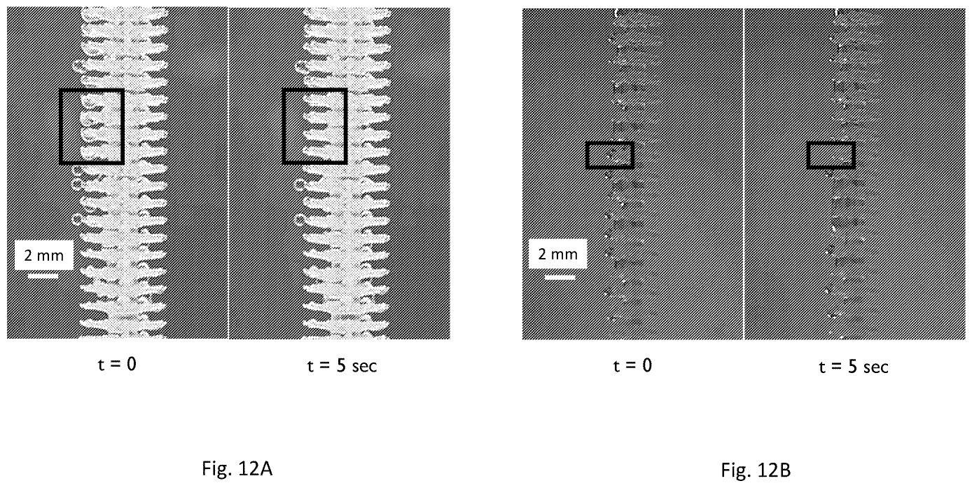

FIG. 1B shows wicking transport structures with trichomes in accordance with an illustrative embodiment. The wicking transport structures with trichomes are formed by clamping short segments of material between the twisted or braided wires (i.e., core), as shown. FIG. 1C depicts a three dimensional (3D)-printed wicking transport structure in accordance with an illustrative embodiment. As discussed in more detail below, FIGS. 11A, 11B, 12A, and 12B also depict 3D-printed wicking transport structures. These examples can be manufactured in many different configurations due to the versatility of 3D printing. As discussed herein, various configurations can be used for the wicking transport structures. For example, the wicking transport structure may have a non-helical core (fluted, internal channel, polygonal, rough, smooth, rectangular, etc.) or non-linear cores (zig-zag, wavy, etc.). The wicking transport structure may also have a core with no integrated channels, such as a smooth cylinder with trichomes. A cross-section of the trichome layer can be cylindrical or non-cylindrical (e.g., elliptical, rectangular, square, etc.). The trichomes can have various shapes such as round, flat fins, rectangular, curly, looping, spongy, etc. and/or different flexural stiffnesses. Additionally, a wicking transport structure can have non-uniform properties along its length, including trichomes protruding at different angles relative to an axis of the core, trichomes of differing sizes along the core, trichomes of differing types/shapes along the core, various spatial densities of trichomes along the core, etc. Various configurations of wicking transport structures and their components are depicted in FIG. 1, FIGS. 7-10, and FIG. 16.

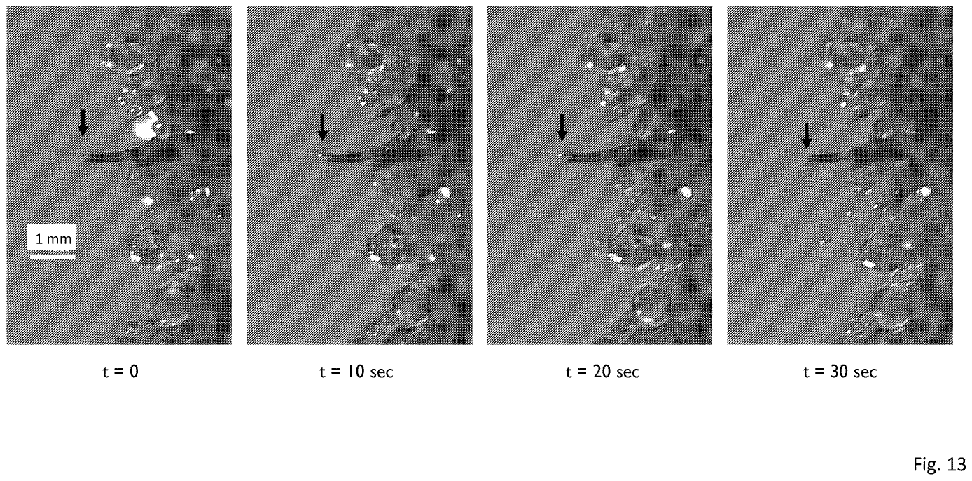

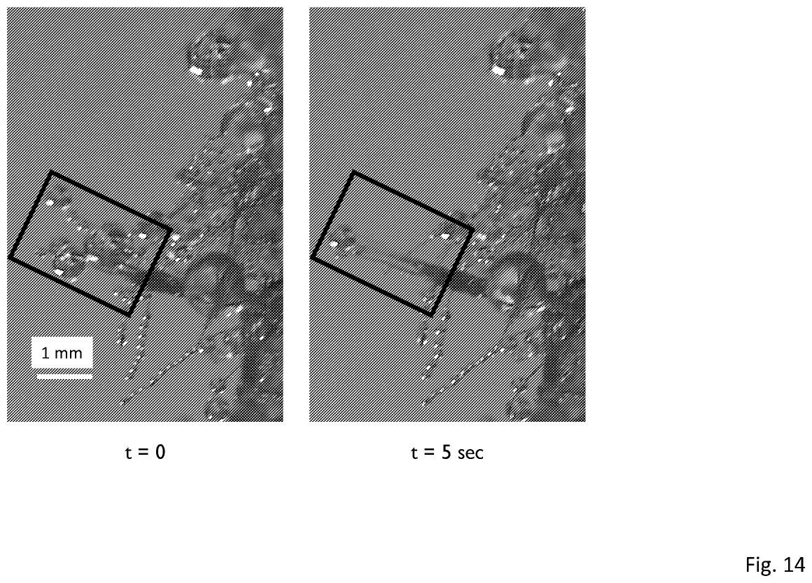

Trichomes may facilitate various different mechanisms for transporting captured fog droplets towards the core. FIG. 13 shows a closeup view of a cluster of flexible trichomes that have formed into a conical shape. In this instance, a number of flexible trichomes have become clustered into a conical shape by the surface tension of some previously-captured water. When the highlighted captured droplet comes into contact with the water within the conical cluster of trichomes, it is rapidly absorbed into the cluster and transported toward the core of the wicking transport structure. FIG. 14 shows a closeup view of another wicking transport structure with flexible fiber trichomes. As shown, a large number of fog droplets have been captured on adjacent trichomes and trichome clusters. When these droplets contact each other and coalesce, the trichomes and trichome clusters elastically deform and rapidly transport the water towards the core of the wicking transport structure. The elastic restoring force of the deformed trichomes is imparted onto the droplet, assisting in its transport toward the core.

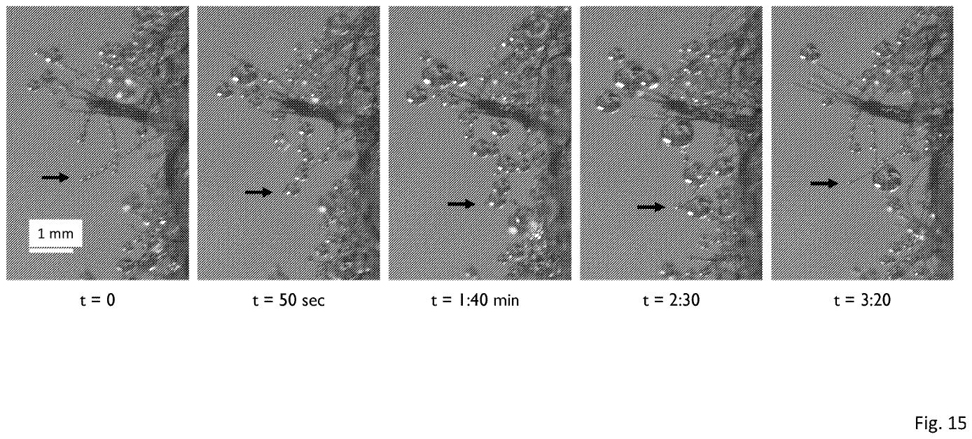

FIG. 15 shows a closeup view of a trichome on a wicking transport structure being deformed by the increasing gravitational force on captured droplets as they grow and coalesce. Once the droplets contact other droplets nearer to the core and detach from the deformed trichome, the trichome returns to its undeformed position. Additionally, wicking transport structures with rigid trichomes that do not substantially deform also efficiently transport water toward their cores. FIGS. 12A and 12B show 3D-printed wicking transport structures with rigid trichomes. Rapid transport of captured droplets from the tips of the rigid trichomes towards the core of the wicking transport structure is observed. Many other mechanisms not described here contribute to the ability of various types of trichomes to transport captured fog droplets toward the cores of their wicking transport structures.

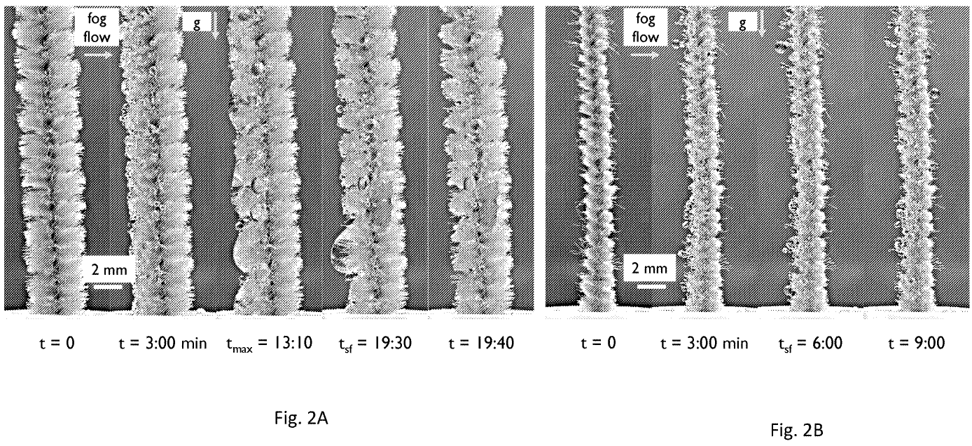

FIGS. 2A and 2B show the development of continuous fluid streams within two wicking transport structures when exposed to a constant 5 meters/second (m/s) simulated fog stream. Initially, fog water accumulates on the collector but does not flow into the collection container below except for occasional small drops. At a maximum accumulation time (tₘₐₓ), the amount of large water droplets that are pinned in place reaches its peak. After this point, droplets gradually begin to unpin and cascade downward into the collection container. At steady flow time (t_{sf}), a larger surge of water suddenly begins to enter the collection container, indicating the formation of a continuous fluid stream in the center of the wicking transport structure that continues to flow steadily until the end of the experiment. FIG. 2A shows a 6.1 millimeter (mm) diameter wicking transport structure in accordance with an illustrative embodiment. FIG. 2B shows a 2.5 mm diameter wicking transport structure in accordance with an illustrative embodiment. The collector of FIG. 2A exhibits very different behavior and delayed t_{sf} when compared to the 2.5 mm diameter wicking transport fog collector of FIG. 2B. This variance demonstrates that wicking transport structures can be optimized for different applications. The variance also shows that commercial chenille-type wicking transport structures can be specially designed for these applications.

Continuous fluid streams can be formed by wicking transport structures with smooth cores that have no channels. The interstitial spaces between the trichomes of such a wicking transport structure are sufficient to product continuous fluid streams. FIGS. 12A and 12B show two wicking transport structures with smooth cylindrical cores which lack external channels. These wicking transport structures with smooth cores formed continuous fluid streams and had similar fog collection rates to chenille-type wicking transport structures.

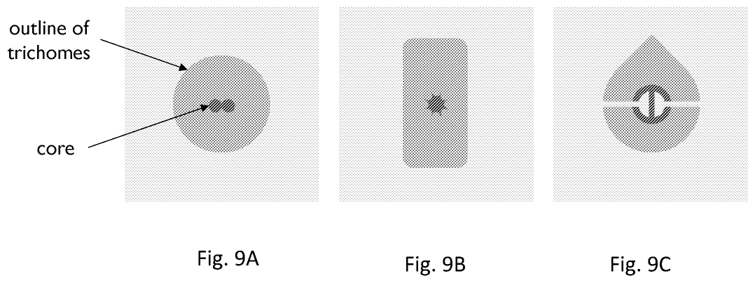

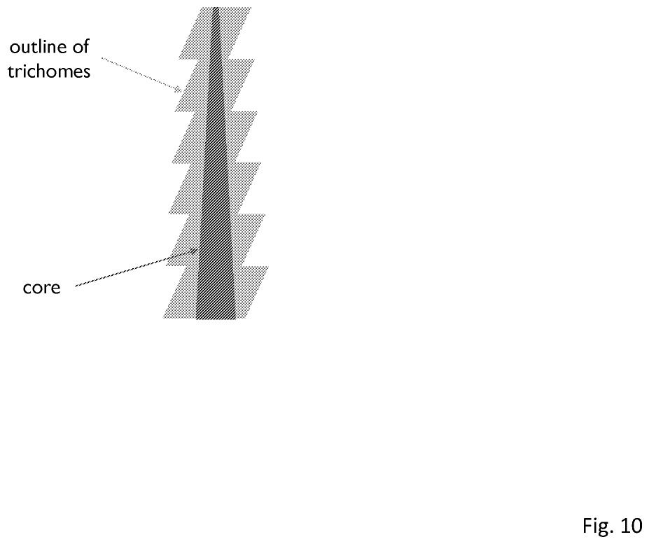

The inventors have developed several prototype fog collectors containing integrated wicking transport structures made from common chenille wires. These wicking transport structures are made of many short segments of polyester fiber (7 mm length, ~0.015 mm diameter) or metal strips acting as trichomes clamped between two metal wires that are twisted together to form a core. These trichomes form a densely-packed cylindrical brush-like structure around the wire core. The number of fibers is adjusted to achieve the desired spatial density of trichomes. The fibers are trimmed to the desired outer size and shape. The tips of the polyester fibers act as a high-St fog collection structure of trichomes, while the core and the bases of the trichomes interact to form a continuous fluid stream to transport captured water downward in response to gravity. In several experiments, it was shown that these wicking transport structures effectively transport captured fog droplets from the tips of the trichomes to the bulk outlet below. The trichomes can be positioned at a plurality of different angles relative to the core axis, such as 90° (i.e., perpendicular to the core), 15°, 30°, 45°, 60°, 75°, 105°, 120°, 135°, 150°, 165°, etc. As discussed in more detail below (see FIGS. 9-10), the trichomes can include various outlines such as a cylindrical outline, a rectangular outline, an irregularly-shaped outline, etc. The trichomes can also be asymmetric, and the shape/size/position of the trichomes can vary along the length of the core of the wicking transport structure.

The proposed fog collectors with wicking transport structures also exhibit extremely high St and η, outperforming fog harps and other fog collectors that use clogging-reduction mechanisms. In order to study the performance of various fog collectors in a controlled and repeatable fog flow, the inventors tested them in a closed-loop wind tunnel. This closed-loop style of tunnel continuously recirculates the same mass of fog-laden air so that the fog droplet size and distribution remain steady over time. At one point in the loop, fog droplets were continuously generated by humidifiers and thoroughly mixed throughout the flow stream to replace fog droplets that were captured by various surfaces in the wind tunnel loop. The fog flow was then conditioned by passing it through mesh screens, honeycomb flow straighteners, and a contraction to reduce vorticity and improve velocity uniformity within the flow.

This conditioned fog flow then entered the test section, where test samples were exposed to the flow. After passing through the test section, the fog flow passed through a diffuser and a duct fan which drove the flow through the tunnel. Upon exiting the fan, the fog flow again entered the humidifier and mixing section before repeating the entire cycle. Individual fog collector samples were mounted in the center of the test section. Water collected by samples flowed down into a drip funnel and was collected in a sealed container below the test section. The sample mounts were designed so that water captured by the mounts was carefully directed away from the sample and drip funnel. A 50 mm segment of each sample was exposed to the flow between the mount and drip funnel. The mount and drip funnel were long enough to keep the exposed portion of each sample out of the boundary layer flow near the walls of the test section.

The wind tunnel experiments were used to compare the performance of wicking transport structures to other fog collectors. Thin 0.32 mm aluminum wires were used to replicate the performance of current state-of-the-art fog collectors. Aluminum is naturally hydrophilic, so some samples were left untreated while others were Boehmitized to produce a fragile superhydrophilic nanostructure on their surfaces. Hydrophobic and superhydrophobic wires were not used because their performance suffers from re-entrainment. The untreated and Boehmitized SHPhi aluminum wires simulate fog harps, or highly-tensioned harp-like arrays of vertical cylinders with no horizontal structures, which eliminate the intersections between wires where water droplets frequently pin in mesh-type fog collectors. The lack of horizontal structures causes fog harps to tangle and clog if the harp wires are too close together, too long, or under inadequate tension to keep from fluttering too close to one another. Regardless, short hydrophilic fog harps (<1 m tall) exhibit excellent η_{d} and η_{dr} due to their high St values and lack of droplet pinning sites, outperforming most other fog collector designs.

For fog collectors that include a simple geometry repeated over and over at some interval, it is useful to test and make observations of these ‘subcomponent units.’ For fog harps, the subcomponent unit that is repeated at equal intervals is a single straight wire. For fog collectors made up of repeated wicking transport structures, the subcomponent unit is a single wicking transport structure. In order to simplify the experimental setup, the fog collection rate per unit area (v′) of various fog collector designs were measured by testing their subcomponent unit individually. Testing individual subcomponent units sets η_{ac} equal to 1, which allows for more direct comparisons of η_{d} and η_{dr} between different fog collector designs. Testing an individual subcomponent unit reduces the overall obstruction of flow in the wind tunnel test section so that characteristics of the oncoming fog flow do not vary from sample to sample.

Fog collectors made from multiple adjacent subcomponent units should have their subcomponent units spaced far enough apart to prevent clogging. The minimum clogging-free spacing between subcomponent units corresponds to a maximum AF_{c} (AF_{c,max}). The value AF_{c,max} is the maximum collector area fraction corresponding to a minimum clogging-free spacing between adjacent subcomponent units. In order to extrapolate experimental fog collection rates per area of individual subcomponent units (vᵤ′) to predict fog collection rates per area of full fog collectors composed of many side-by-side subcomponent units (v_{c}′), the frontal area measurement was adjusted to account for the minimum allowable spacing between adjacent subcomponent units, as shown in Equation 7:

$${v}_{c}^{′} = {v}_{u}^{′} \cdot {AF}_{c , max} \qquad Eq . 7$$

Several stereolithography (SLA) 3D-printed hydrophilic polymer cylinders were also tested to represent solid cylinders with similar outer diameters to the tested wicking transport structures. These are used for comparison and to demonstrate that v′ typically decreases when the diameter of solid cylinders increases. The SLA cylinders also represent subcomponent units of corresponding fog harps with wires of corresponding diameter.

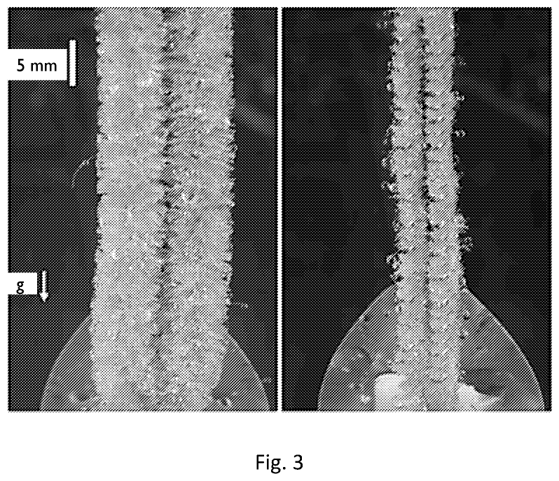

Different AF_{c} values were used to estimate v_{c}′ for different fog collector designs. Fog harps with 0.32 mm untreated hydrophilic wires require a low AF_{c} (<0.4) to prevent clogging and tangling due to the formation of large pinned droplets as captured fog coalesces. In comparison, wicking transport structures can be packed much more densely into full fog collectors without clogging. Chenille-type wicking transport structures do not clog even when adjacent wicking transport structures come into contact. FIG. 3 depicts pairs of wicking transport structures after 30 minutes of exposure to 5 m/s fog flow in accordance with an illustrative embodiment. The images in FIG. 3 are shown from above at a 30° angle to the flow direction. As shown, there is no clogging even in areas where the adjacent wicking transport structures are in contact.

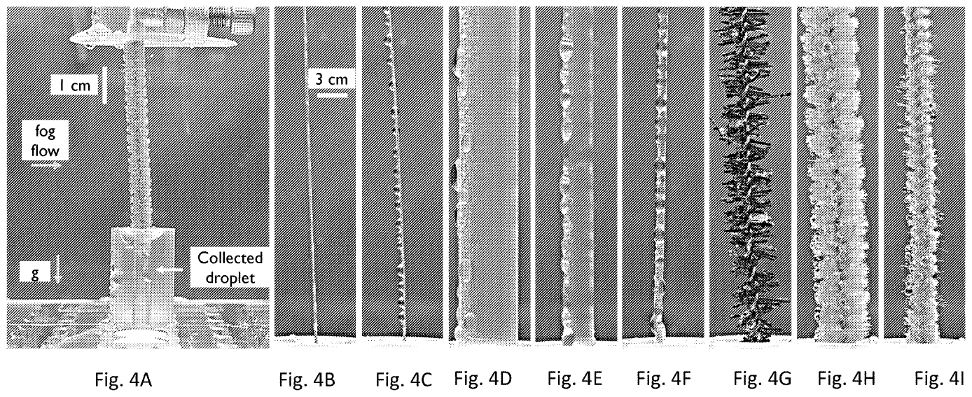

FIGS. 4A-4I depict subcomponent units of fog harps and individual wicking transport structures that were exposed to 5 m/s fog flow for 25 minutes. Specifically, FIG. 4A depicts an experimental setup within a fog wind tunnel, showing a sample wicking transport structure, the sample mount above, and the drip funnel below in accordance with an illustrative embodiment. This equipment is designed to measure only the water collected from fog by each sample. Several cylindrical collectors were also tested. FIG. 4B shows 0.32 mm diameter SHphi aluminum wires used for comparison in accordance with an illustrative embodiment. FIG. 4C depicts 0.32 mm diameter Hphi aluminum wires used for comparison in accordance with an illustrative embodiment. FIG. 4D shows 6.35 mm diameter stereolithography 3D-printed (SLA) cylinders used for comparison in accordance with an illustrative embodiment. FIG. 4E shows 3 mm diameter SLA cylinders used for comparison in accordance with an illustrative embodiment. FIG. 4F shows 0.8 mm diameter SLA cylinders used for comparison in accordance with an illustrative embodiment. Three varieties of chenille-type wicking transport structures were also tested. FIG. 4G shows 5.6 mm diameter wicking transport structures with coarse trichomes in accordance with an illustrative embodiment. FIG. 4H shows 6.1 mm diameter wicking transport structures with fine trichomes in accordance with an illustrative embodiment. FIG. 4I shows 2.5 mm diameter wicking transport structures with fine trichomes in accordance with an illustrative embodiment. Unlike previously-developed arrangements of densely-packed thin structures, these wicking transport structures effectively transport captured water without clogging. Oncoming fog flows throughout these thin structures, producing greatly increased St and fog collection rates compared to solid cylinders with similar outer diameters.

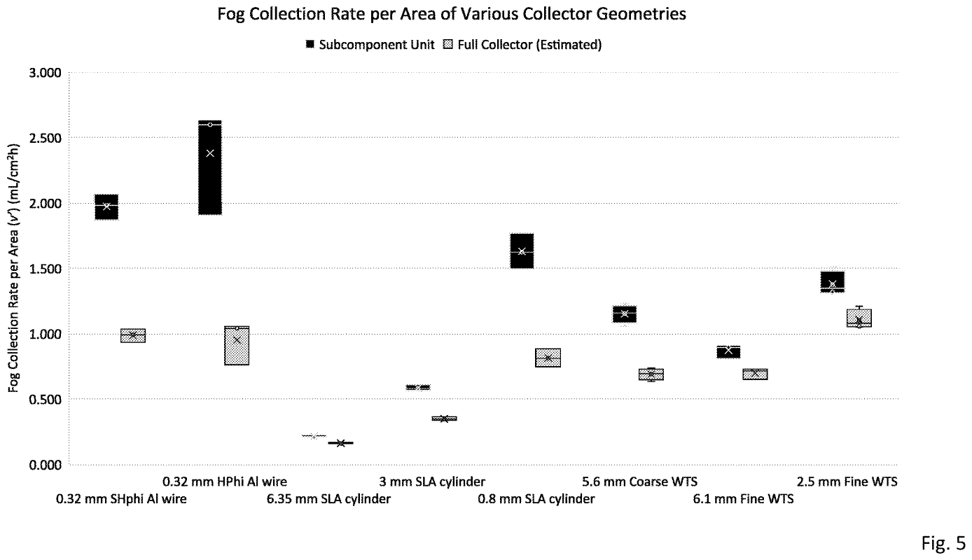

The 2.5 mm diameter wicking transport structures were able to achieve excellent subcomponent unit fog collection rates (vᵤ′)—more than twice those of a similarly-sized 3 mm diameter cylinder. In the analysis described below with reference to FIG. 5, the inventors used AF_{c} values of 0.8 and 0.6 for fog collectors consisting of fine and coarse Wicking Transport Structures, respectively. These AF_{c} values account for the open-air gaps present between the spikes of chenille-type wicking transport structures. In the tests, wicking transport structures achieved superior v_{c}′ compared to 0.32 mm aluminum wire harps.

FIG. 5 is a chart showing fog collection rate per area of subcomponent units of various fog collector designs and estimated fog collection rates of corresponding full fog collectors after 30 minutes of exposure to 5 m/s fog flow in accordance with an illustrative embodiment. It is noted that as subcomponent units, the fine wicking transport structures greatly outperform the comparably-wide 3 mm diameter and 6.35 mm diameter SLA cylinders. As a full collector, the 2.5 mm wicking transport structures exhibit the best estimated fog collection rate per area overall. Even when the full collector performance of 0.32 mm diameter hydrophilic aluminum wires is calculated with an optimistic AF_{c} of 0.4, the 2.5 mm diameter wicking transport structures with fine trichomes still outperform them in v_{c}′. Constructing a fog harp fog collector with thin wires with an AF_{c} as high as 0.4 is very difficult, as the wires must be very short and highly tensioned to prevent them from fluttering and adhering to one another to the point that the collector becomes ineffective. This constraint greatly increases the complexity and cost of a fog harp fog harvester's structural frame compared to the frame that can be used for a similarly-sized fog harvester with wicking transport structures.

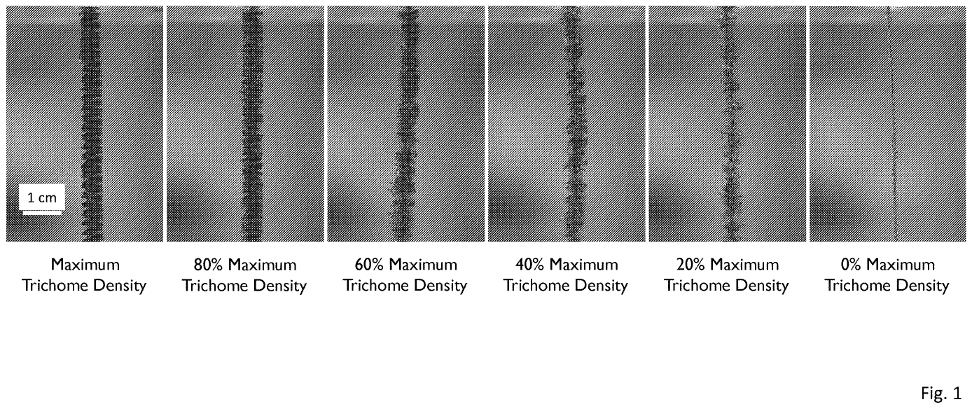

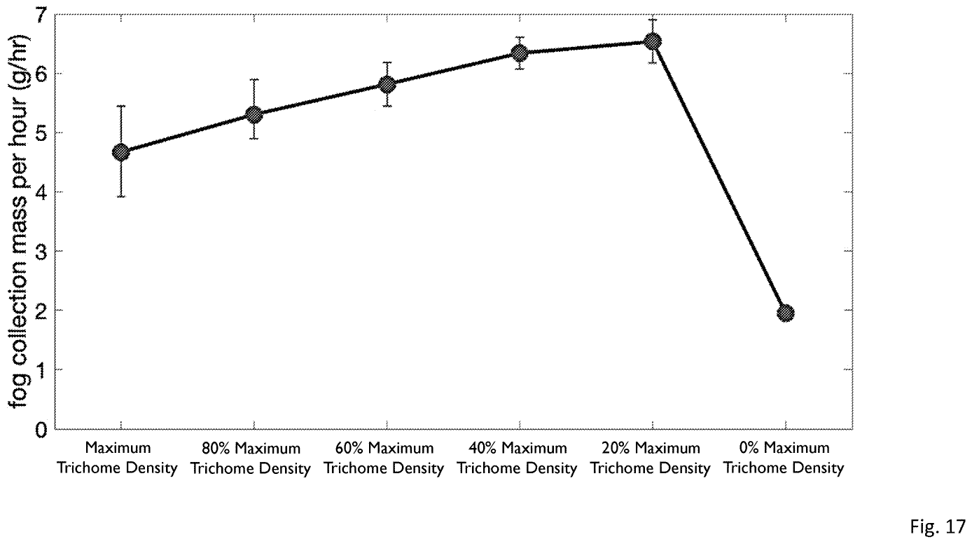

FIG. 16 shows equal lengths of various 6 mm diameter wicking transport structures having different densities of trichomes in accordance with an illustrative embodiment. FIG. 17 is a chart showing fog collection rates of equal lengths of 6 mm diameter wicking transport structures having different spatial densities of trichomes during exposure to 5 m/s fog flow in accordance with an illustrative embodiment. It is noted that the fog collection mass per hour increases as the spatial density of trichomes is decreased within a certain range of densities. This suggests that high fog collection rates of wicking transport structures can be achieved with less spatially-dense arrangements of trichomes than those found on commercial chenille wires. These results indicate that fog harvesters with wicking transport structures may be designed to allow air to flow through them with less flow resistance than would be encountered by air flowing through other varieties of fog harvesters.

The proposed wicking transport structures eliminate clogging throughout fog collectors, including at intersections with perpendicular wires or other structural elements, a unique feature that has never before been achieved. When wicking transport structures are placed in contact with various horizontal wires, they are able to completely prevent droplet pinning and clogging at these intersections. The inventors have not found any mention in the literature of another system that is able to eliminate pinning at such intersections. Existing solutions either eliminate these intersections (fog harps) or ignore the droplet pinning that occurs at intersections (simple meshes), with either option having severe consequences for efficiency and practicality. Even aluminum wires with superhydrophilic coatings cannot eliminate clogging at intersections with low-wettability wires. In contrast, the proposed wicking transport structures are able to prevent clogging at intersections with wires of all wettabilities.

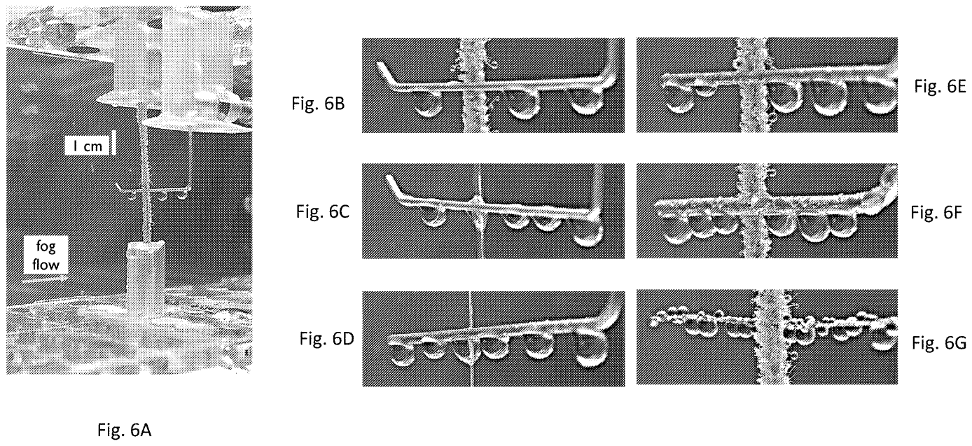

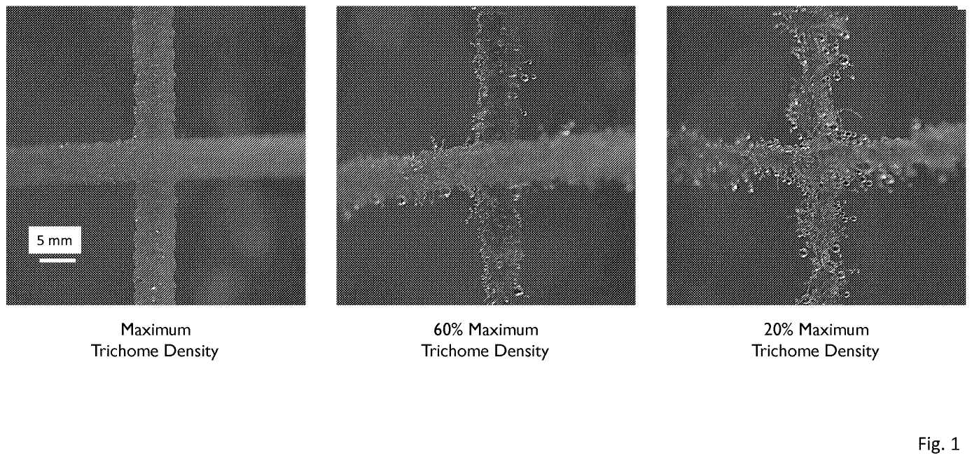

FIGS. 6A-6G show an experimental setup within the test section of a fog-simulating wind tunnel, showing different droplet pinning behavior at the intersections of various structures. All views were taken at the same 45° angle to the flow direction after several minutes of fog flow. FIG. 6A shows a horizontal section of aluminum wire with a superhydrophilic (SHPhi) surface coating that is placed in contact with a vertical wicking transport structure in accordance with an illustrative embodiment. FIG. 6B is a closeup view of FIG. 6A which shows the complete lack of droplet pinning at the intersection in accordance with an illustrative embodiment. FIG. 6C shows that significant droplet pinning occurs between horizontal superhydrophilic aluminum wires and vertical untreated hydrophilic (HPhi) aluminum wires in accordance with an illustrative embodiment. FIG. 6D shows that significant droplet pinning occurs between horizontal and vertical untreated hydrophilic aluminum wires in accordance with an illustrative embodiment. All assortments of wires and structures with various surface wettabilities exhibit this behavior, which causes fog collector clogging. In contrast, wicking transport structures eliminate all clogging at the intersections of all horizontal wires that were tested. FIG. 6E shows how vertical wicking transport structures show a complete lack of droplet pinning when placed in contact with horizontal untreated hydrophilic aluminum wires in accordance with an illustrative embodiment. Additionally, wicking transport structures prevent clogging at intersections with especially thick and thin diameter horizontal wires. FIG. 6F shows wicking transport structures eliminating clogging at intersections with relatively thick 2 mm diameter horizontal wires in accordance with an illustrative embodiment. FIG. 6G shows wicking transport structures eliminating clogging at intersections with relatively thin 0.32 mm diameter horizontal wires in accordance with an illustrative embodiment. FIG. 18 shows another experimental setup within the test section of a fog-simulating wind tunnel, showing different droplet pinning behavior at the intersections of various wicking transport structures. More specifically, FIG. 18 shows the complete lack of droplet pinning at the intersections between 6 mm diameter wicking transport structures that have different spatial densities of trichomes in accordance with an illustrative embodiment.

The above-discussed anti-clogging behavior allows wicking transport structures to be woven into mesh-like fog collectors in conjunction with perpendicular and multidirectional wires and other structural elements with little pinning at intersections and minimal detriment to η_{dr}. Perpendicular or multidirectional structures give fog collectors with wicking transport structures the strength of large textile structures, whereas fog harps and all other designs without multidirectional structures tend to flutter incoherently in the wind. This also enables wicking transport fog collectors to far surpass existing high-η_{dr} fog collector designs in strength, durability, practicality, and cost-effectiveness.

In addition, wicking transport structures shield captured water streams from passing airflow, reducing re-entrainment at high fog flow speeds. A key advantage of using wicking transport structures with trichomes is that continuous fluid streams primarily form internally within these structures. In contrast, previously proposed transport mechanisms simply reduce the contact angle hysteresis drag on an uncontrolled external water stream. The internal streams enabled by wicking transport structures offer many advantages over existing transport mechanisms. First, uncontrolled external streams vary in shape and size depending on the fog collection rate, fog flow rate, and other factors. At different collection rates, uncontrolled external streams swell due to viscous friction, deviate due to aerodynamic drag forces, and clog air passages. The aerodynamic geometry of fog collectors with uncontrolled external streams changes dramatically between dry and varying wet states, complicating their design. Such geometry changes are made more predictable by wicking transport structures with constrained internal streams. Second, internal streams are more shielded from re-entrainment than external streams, which improves η_{dr} at higher fog flow speeds.

The proposed system is also less expensive to produce. Wicking transport structures require no coatings, surface treatments, or specialized materials, which dramatically increases durability, scalability, and cost-effectiveness in real-world applications when compared to existing fog collector designs. By using macroscale geometries and texturing, wicking transport structures can achieve unprecedented properties while being made from a wide range of inexpensive materials such as aluminum wire and monofilament thread without specialized coatings. The inventors have demonstrated that wicking transport structures can even be made from hydrophobic materials such as polyester. Wicking transport structures can be 3D-printed, allowing for rapid customization and performance maximization for niche applications.

Although specific fog collector implementations have been depicted and described with reference to FIGS. 1-6, it is important to understand that the proposed system is not so limited. In alternative implementations, the wicking transport structures can include different types of cores (i.e., different cross-sections), different overall shapes, different trichome outlines, etc. FIGS. 7-10 depict example alternative implementations that can be used in the proposed system. In additional alternative embodiments, different configurations may be used and the embodiments of FIGS. 7-10 are not meant to be limiting.

FIG. 7 shows various possible configurations for the core of a wicking transport structure. FIG. 7A shows a cross-section of a wicking transport structure core made from twisted wires in accordance with an illustrative embodiment. FIG. 7B shows a cross-section of a smooth cylindrical wicking transport structure core that has no external channels in accordance with an illustrative embodiment. FIG. 7C shows a cross-section of a roughly-textured wicking transport structure core in accordance with an illustrative embodiment. FIG. 7D shows a cross-section of a polygonal wicking transport structure core in accordance with an illustrative embodiment. FIG. 7E shows a cross-section of a fluted wicking transport structure core in accordance with an illustrative embodiment. FIG. 7F shows a cross-section of a wicking transport structure core with internal channels in accordance with an illustrative embodiment. In alternative embodiments, a different cross-sectional shape of the wicking transport structure core may be used.

FIG. 8 shows various example configurations of wicking transport structures that can be used. FIG. 8A shows a cross-section of a wavy non-planar fog collector made up of many wicking transport structures in accordance with an illustrative embodiment. FIG. 8B shows a cross-section of a pleated non-planar fog collector made up of many wicking transport structures in accordance with an illustrative embodiment. FIG. 8C shows a cylindrical non-planar fog collector with wicking transport structures in accordance with an illustrative embodiment. FIG. 8D shows conical and domed non-planar fog collectors with wicking transport structures in accordance with an illustrative embodiment. In alternative embodiments, a different shape of fog collectors with wicking transport structures may be used.

FIG. 9 shows various example trichome outlines that may be used to form the wicking transport structures. FIG. 9A shows a cross-section of a wicking transport structure with a cylindrical trichome outline in accordance with an illustrative embodiment. FIG. 9B shows a cross-section of a wicking transport structure with a rectangular trichome outline in accordance with an illustrative embodiment. FIG. 9C shows a cross-section of a wicking transport structure with an irregularly-shaped trichome outline in accordance with an illustrative embodiment. In alternative embodiments, different trichome outlines may be used.

FIG. 10 shows a side view of a wicking transport structure with asymmetrical features that vary along its length in accordance with an illustrative embodiment. As shown, the asymmetrical features are rectangular shaped trichome outlines of varying size. The asymmetrical features can alternatively be circle shaped trichome outlines, square shaped trichome outlines, oval shaped trichome outlines, etc. In another embodiment, the asymmetrical features can be a combination of different types of trichome outlines, such as a combination of circular and rectangular trichome outlines.

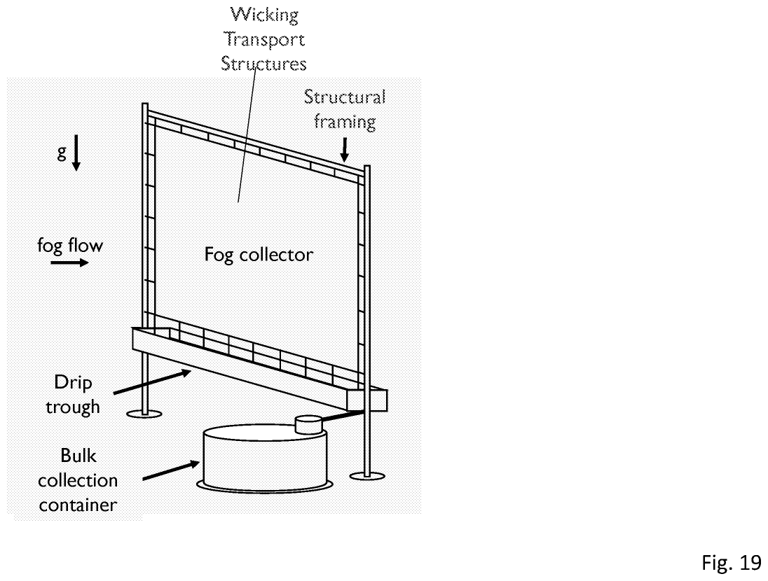

FIG. 19 depicts a fog harvesting system in accordance with an illustrative embodiment. The fog harvesting system includes a plurality of wicking transport structures vertically mounted to a frame (i.e., structural framing). The vertical wicking transport structures are connected to one another by way of horizontal wires that connect to each of the wicking transport structures to form a weave that can be hunt from any frame. When placed in the path of fog, the fog harvesting system collects water drops on the wicking transport structures, which direct water flow (due to gravity) into a drip trough. A hose (or tube) connects the drip trough to a bulk collection container (or reservoir). In alternative embodiments, a different configuration may be used.

Thus, described herein are fog collection systems with wicking transport structures that act as fog collection structures with extremely high Stokes numbers and overall fog collection efficiencies, outperforming fog harp fog collectors and other existing systems. The proposed structures capture and rapidly absorb droplets and transport them through a continuous fluid stream to a bulk outflow. The structures eliminate clogging throughout fog collectors, including at intersections with perpendicular wires or other structural elements, which is a unique feature that has never before been achieved. The proposed wicking transport structures also shield captured water streams from passing airflow, reducing re-entrainment at high fog flow speeds. The proposed structures do not need to have coatings, surface treatments, or specialized materials, which dramatically increases durability, scalability, and cost-effectiveness in real-world applications when compared to existing fog collector designs. Additionally, the proposed system can be easily integrated with other technologies such as electrostatic droplet attraction to enable fast, ultra-high-efficiency transport of collected water.

The proposed systems can be used to provide a new source of water for municipal water supply, crop irrigation, and industry in any region throughout the world. The systems can also be used to collect and eliminate airborne liquid droplet waste in industrial cooling towers. Also, the proposed systems can be incorporated into electrostatic fog harvesting systems that can attract fog droplets very efficiently by using electric charges. The application of wicking transport structures in such electrostatic systems could eliminate clogging and re-entrainment, allowing them to operate more efficiently and in more extreme flow environments. The proposed wicking transport structures can also be used for dew harvesting, where water is captured from the atmosphere by condensation. Where fog frequently obscures roadways and airstrips, installing fog harvesters with wicking transport structures can improve visibility and safety. Additionally, wicking transport structures can efficiently separate suspended liquid droplets from gas streams or streams of another immiscible fluid. This is useful in oil and gas production, oil spill cleanup, and chemical processing.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A system for harvesting fog, the system comprising:
a core, wherein the core is in the form of a rod-like structure that is configured to direct accumulated fog droplets in a downward direction;
a plurality of trichomes mounted to the core such that each of the trichomes is configured to accumulate the fog droplets, wherein there are interstitial spaces in between trichomes to wick the fog droplets and coalesce them into one or more continuous fluid streams along a length of the core; and
a bulk outflow to which the accumulated fog droplets are directed in the downward direction along the core.

2. The system of claim 1, wherein the core comprises a pair of wires that are twisted together to form a helical channel.

3. (canceled)

4. The system of claim 1, further comprising a frame to which the core is mounted such that the core is positioned at an angle relative to a ground surface.

5. The system of claim 1, further comprising one or more tubes or troughs that are configured to receive the accumulated fog droplets from an end of the core and direct the accumulated fog droplets to the bulk outflow.

6. The system of claim 5, wherein a tube of the one or more tubes includes an opening sized to receive a bottom tip of the core such that the accumulated fog droplets release from the bottom tip of the core directly into the tube.

7. The system of claim 1, wherein the plurality of trichomes are thin, flexible fibers.

8. (canceled)

9. The system of claim 1, wherein the core includes one or more internal channels.

10. The system of claim 1, wherein the trichomes are at an angle of between 0° and 180° relative to the core.

11. (canceled)

12. (canceled)

13. (canceled)

14. The system of claim 1, wherein the plurality of trichomes includes trichomes having different flexural stiffness such that the core has non-uniform properties along its length.

15. The system of claim 1, wherein the plurality of trichomes includes trichomes mounted at different angles relative to an axis of the core such that the core has non-uniform properties along its length.

16. The system of claim 1, wherein the plurality of trichomes includes trichomes having different lengths or shapes such that the core has non-uniform properties along its length.

17. The system of claim 1, wherein spacing between trichomes varies along a length of the core such that the core has varying spatial density of trichomes along its length.

18. A method of forming a fog harvesting system, the method comprising:
forming a core as rod-like structure that is configured to direct accumulated fog droplets in a downward direction;
mounting a plurality of trichomes to the core such that each of the trichomes is configured to accumulate the fog droplets, wherein the plurality of trichomes are mounted such that interstitial spaces are formed between trichomes to wick the fog droplets and coalesce them into one or more continuous fluid streams along a length of the core; and
positioning a bulk outflow to collect the accumulated fog droplets that are directed in the downward direction along the core.

19. The method of claim 18, further comprising twisting a pair of wires together to form the core as a helical channel.

20. The method of claim 18, further comprising forming a frame and mounting the core to the frame such that the core can be positioned at an angle relative to a ground surface.

21. The method of claim 18, further comprising positioning one or more tubes or troughs to receive the accumulated fog droplets from an end of the core.

22. (canceled)

23. The method of claim 21, wherein a tube of the one or more tubes includes an opening sized to receive a bottom tip of the core such that the accumulated fog droplets release from the bottom tip of the core directly into the tube.

24. The method of claim 18, further comprising:
forming the plurality of trichomes as thin, flexible fibers; and
mounting the thin, flexible fibers by positioning a portion of the fibers in between wires that form the core.

25. The method of claim 18, further comprising forming the core as a braid of two or more wires, and applying a texture to an outer surface of the core.

26. The method of claim 18, further comprising forming one or more internal channels in the core.
